(19) United States
(12) Patent Application Publication
(10) Pub. No.: US 2025/0299021 A1
(43) Pub. Date: Sep. 25, 2025

(54) SYSTEM AND METHOD FOR TRAINING AN ARTIFICIAL INTELLIGENCE MODEL WITH MICROSERVICE TRAFFIC

(71) Applicant: KONG INC., San Francisco, CA (US)

(72) Inventors: Marco Palladino, San Francisco, CA (US); Saju Pillai, San Francisco, CA (US)

(21) Appl. No.: 18/612,518

(22) Filed: Mar. 21, 2024

(51) Int. Cl. G06N 3/0455; G06F 9/54; G06N 3/084

(52) U.S. Cl. CPC G06N 3/0455; G06F 9/547; G06N 3/084

(57) ABSTRACT

The technology discloses a method for training a model tailored to a service through the service Application Programming Interface (API) traffic. The system provides a microservice architecture application with a plurality of services, where one or more of the services have existing API traffic. An API gateway intercepts the API traffic being received by or sent from the service. The API gateway then identifies the training data from the existing API traffic, and uses the identified training data to generate a specialized model. The specialized model captures patterns or behaviors observed within the API traffic.

### BACKGROUND

Artificial intelligence (“AI”) models often operate based on extensive and enormous training models. The models include a multiplicity of inputs and how each should be handled. Then, when the model receives a new input, the model produces an output based on patterns determined from the data the model was trained on.

Application programming interfaces (APIs) are specifications primarily used as an interface platform by software components to enable communication with each other. For example, APIs can include specifications for clearly defined routines, data structures, object classes, and variables. Thus, an API defines what information is available and how to send or receive that information.

Microservices are a software development technique—a variant of the service-oriented architecture (SOA) architectural style that structures an application as a collection of loosely coupled services (embodied in APIs). In a microservices architecture, services are fine-grained and the protocols are lightweight. The benefit of decomposing an application into different smaller services is that it improves modularity. This makes the application easier to understand, develop, test, and become more resilient to architecture erosion. Microservices parallelize development by enabling small autonomous teams to develop, deploy, and scale their respective services independently. Microservice-based architectures enable continuous delivery and deployment.

### BRIEF DESCRIPTION OF THE DRAWINGS

FIG. 1 is a block diagram illustrating an API gateway in the context of microservices, according to an embodiment of the disclosed technology.

FIG. 2 is a block diagram illustrating training the model using API traffic, according to an embodiment of the disclosed technology.

FIG. 3 is a flowchart illustrating a method for training an AI model using existing API traffic, according to an embodiment of the disclosed technology.

FIG. 4A is a block diagram illustrating a microservice architecture application with an API gateway as an endpoint, according to an embodiment of the disclosed technology.

FIG. 4B is a block diagram illustrating a microservice architecture application with multiple API gateways, according to an embodiment of the disclosed technology.

FIG. 5 is a block diagram illustrating components and associated steps involved in generating training data from the existing API traffic, according to an embodiment of the disclosed technology.

FIG. 6 is a block diagram illustrating the categorizing of the existing API traffic by variables, according to an embodiment of the disclosed technology.

FIG. 7 is a block diagram illustrating observing the API traffic for a predetermined observation period, according to an embodiment of the disclosed technology.

FIG. 8 is a block diagram illustrating modifying new API traffic using the specialized model, according to an embodiment of the disclosed technology.

FIG. 9 is a block diagram illustrating generating performance metrics for the specialized model to iteratively refine the specialized model, according to an embodiment of the disclosed technology.

FIG. 10 is a block diagram illustrating an example computer system, in accordance with one or more embodiments.

FIG. 11 is a high-level block diagram illustrating an example AI system, in accordance with one or more embodiments.

### DETAILED DESCRIPTION

AI models offer a powerful framework for extracting insights and making predictions from data. One of the key advantages of AI models lies in the mode's ability to automatically identify patterns and relationships within complex datasets, even in the absence of explicit programming. The capability enables AI models to uncover relationships, predict future outcomes, and drive data-driven decision-making across various fields.

Traditionally, extracting meaningful insights from API traffic within microservice architectures has been a cumbersome and labor-intensive task that requires developers to manually gather, preprocess, and analyze vast amounts of data to generate an AI model specific to the API traffic for the microservice. For example, the preprocessing stage involves tasks such as data cleaning, normalization, and transformation, all of which consume considerable resources (e.g., time). Furthermore, the complexity of the data can extend the time needed to prepare the data for training a model on the API traffic.

For example, a company operates a microservice architecture to power the company's e-commerce platform. The platform consists of numerous microservices responsible for handling various functionalities such as user authentication, product catalog management, order processing, and payment processing. Traditionally, if the company wishes to extract insights from the API traffic being received by or sent from any specific microservice, developers need to manually identify and collect relevant data (e.g., the API traffic) being sent to and received from each service. Then, the developers need to manually create AI models specific to the feature within the API traffic that the model is predicting and train the model to recognize and respond to patterns and behaviors observed in the data. The process involves designing and implementing machine learning algorithms, fine-tuning model parameters, and validating model performance against historical data.

The ability to train a model autonomously with existing API traffic in real-time, without extensive input from the user, allows for AI models to actively learn from the ongoing stream of API transactions without placing the burden on the developers to direct the AI mode's learning. By autonomously analyzing patterns and behaviors within the API traffic, the model iteratively refines the model's predictive capabilities without external input from the user. This allows microservices to, for example, dynamically adjust their operations in response to changing conditions within the microservice, thus improving performance and resource utilization in real-time.

The API gateway, in real-time, trains an AI model on existing API traffic. The API gateway acts as an intermediary between the microservice and the API and observes the API traffic between the microservice and the API. The API gateway intercepts ongoing API traffic and determines, from the ongoing API traffic, the training data necessary for training the model to improve the model's predictive capabilities. The API gateway then delivers the training data to a training module (e.g., an AI training algorithm) for training the model. The model is then trained on the existing API traffic. The model is trained without further instructions from a user of the microservice. Rather, the API gateway autonomously gathers the training data and forwards the data to train the model.

For example, an owner of an online marketplace encounters a large number of payment requests for the multitude of transactions occurring within the marketplace. The owner would like to block payments for any user who has experienced three or more payment declines within the last hour. The API gateway then, in real-time, captures and analyzes all or a subset of the existing API traffic, extracting training data specifically on payment transactions. The training data is then used to generate a service-specific AI model, which autonomously evaluates each incoming payment request to determine whether or not the request has experienced three or more payment declines within the last hour.

While the present API gateway is described in detail for use with consuming APIs in a microservice context, the API gateway could be applied, with appropriate modifications, to improve the playability of other applications, making the API gateway a valuable tool for diverse applications beyond a microservice context. The examples provided in this paragraph are intended as illustrative and are not limiting. Any other context referenced in this document, and many others unmentioned are equally appropriate after appropriate modifications.

The invention is implemented in numerous ways, including as a process; an apparatus; a system; a composition of matter; a computer program product embodied on a computer-readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description that references the accompanying figures follows. The scope of the invention is limited only by the claims and the invention encompasses numerous alternatives, modifications, and equivalents. Numerous specific details are set forth in the following description in order to provide a thorough understanding of the disclosure. These details are provided for the purpose of example and the invention may be practiced according to the claims without some or all of these specific details. For the purpose of clarity, technical material that is known in the technical fields related to the invention has not been described in detail so that the invention is not unnecessarily obscured.

### AI Model Training with Microservice Traffic

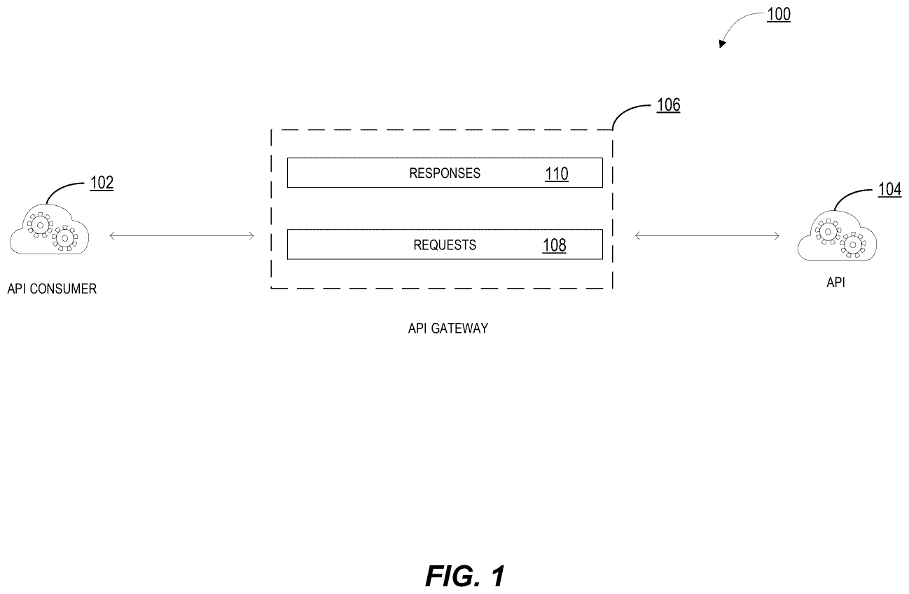

FIG. 1 is a block diagram 100 illustrating an API gateway in the context of microservices, according to an embodiment of the disclosed technology.

API traffic is created when an API consumer 102 sends a communication to an API 104, or receives a communication from the API 104. The API traffic refers to the exchange of data between an API consumer 102 and an API 104. The communication occurs when the API consumer 102, which, in some embodiments, is a service within a microservice application (e.g., client application, a web service, or another software component), initiates a request 108 to the API 104 to perform a specific operation or retrieve information. Conversely, API traffic also encompasses the responses sent back from the API 104 to the API consumer 102, containing the requested data or the outcome of the operation (e.g., response 110).

When an API consumer 102 sends a communication to an API 104, the request 108 is an HTTP request with specific parameters, headers, and/or payload data. For example, an API consumer sends a GET request to retrieve information from a remote server, or a POST request to submit data for processing. The request 108 is transmitted over the network to the API 104. For example, a request 108 for a payment API contains variables such as the user ID that is making the payment, the amount, the date, and the payment outcome. The GET request, for example, is GET/payments/{id}.

On the other hand, when the API 104 processes the request 108 and generates a response 110, the API 104 sends the response back to the API consumer 102. The response 110 contains the requested data or the result of the operation, encoded in a format such as JSON or XML, along with relevant HTTP status codes and headers. For example, the response 110 for the GET request is {“id”: “ABC, “user_id”:123, “amount”:1234, “status”: “DECLINED”, “date”: “some date”, . . . }.

The API gateway 106 is positioned between the API consumer 102 and API 104, and observes the API traffic between the API consumer 102 and API 104. The API gateway 106 is an endpoint and provides a centralized point for API traffic management and monitoring.

In some embodiments, the API gateway 106 observes real-time API traffic, and continuously observes the traffic until a predetermined event triggers a change in the API gateway's operations. The predetermined trigger mechanism enables the API gateway 106 to adapt dynamically to evolving circumstances within the microservices architecture. For example, certain events such as a sudden spike in traffic volume or performing a scheduled maintenance operation can serve as triggers for altering the API gateway's 106 operations. When the predetermined events occur, the API gateway 106 adjusts the API gateway's 106 operations in real-time, such as pausing the observation of the API traffic. In some embodiments, the API gateway 106 continues to pause observing the API traffic until another predetermined trigger occurs (e.g., traffic volume goes below a certain threshold, receiving a manual external input). Once receiving the second predetermined trigger, the API gateway 106 resumes observing the API traffic.

In some embodiments, the API gateway 106 observes real-time API traffic, and continuously observes the traffic until a predefined observation period elapses. In some embodiments, the predefined period is defined based on specific requirements and operational needs of the system, taking into account factors such as expected traffic patterns, peak usage hours, and/or important operational windows. By setting predefined time intervals for observing the API traffic, organizations can ensure that no issues or performance anomalies go unnoticed for prolonged periods. Once the observation period elapses, the API gateway 106, for example, triggers automated actions, generates reports, or initiates further analysis based on the insights gathered during the monitoring phase.

In some embodiments, the API gateway 106 creates copies of the communications of the API traffic between the API consumer 102 and API 104 (e.g., responses 110 and/or requests 108). By creating copies of the API traffic, the API gateway 106 is able to provide the AI model with training data to train the AI model without modifying traffic flow. The specialized model then is able to analyze historical traffic patterns, identify bottlenecks, and refine the model's parameters to improve overall performance and/or scalability using the previously copied API traffic. Additionally, having copies of the API traffic facilitates more efficient troubleshooting and debugging processes by providing a record of previous API traffic between the service and the API.

The API traffic includes responses 110 and/or requests 108. Requests 108 include communications sent from the API consumer 102 to the API 104 that relays the consumer's intentions and data requirements. Requests 108 contain details such as the type of operation to be performed, parameters specifying the desired actions or data filters, authentication credentials, and/or any additional metadata necessary for processing the request. On the other hand, responses 110 represent the data packets sent back from the API 104 to the API consumer 102 in reply to a request 108. Responses 110 contain outcomes of the requested operations, resource data, status codes indicating the success or failure of the requests 108, and/or any additional metadata related to the communication.

In some embodiments, the API gateway 106 is deployed in a cloud environment hosted by a cloud provider, or a self-hosted environment. In a cloud environment, the API gateway 106 has the scalability of cloud services provided by platforms (e.g., AWS, Azure). In some embodiments, deploying the API gateway 106 in a cloud environment entails selecting the cloud service, provisioning resources dynamically through the provider's interface or APIs, and configuring networking components for secure communication. Cloud environments allow the API gateway to handle varying levels of traffic without the need for manual intervention. As the demand for API services grows, additional resources can be automatically provisioned to meet the increased workload. For example, the scalability ensures that the API gateway 106 efficiently handles peak traffic periods without over-provisioning resources during quieter periods, and is able to adapt to evolving traffic demands and quickly respond to changes.

Conversely, in a self-hosted environment, the API gateway 106 is deployed on a private web server. In some embodiments, deploying the API gateway 106 in a self-hosted environment entails setting up the server with the necessary hardware or virtual machines, installing an operating system, and deploying the API gateway 106 application. In a self-hosted environment, organizations have full control over the API gateway 106, which allows organizations to implement customized security measures and compliance policies tailored to the organization's specific needs. For example, organizations in industries with strict data privacy and security regulations, such as finance institutions, are able to mitigate security risks by deploying the API gateway 106 in a self-hosted environment.

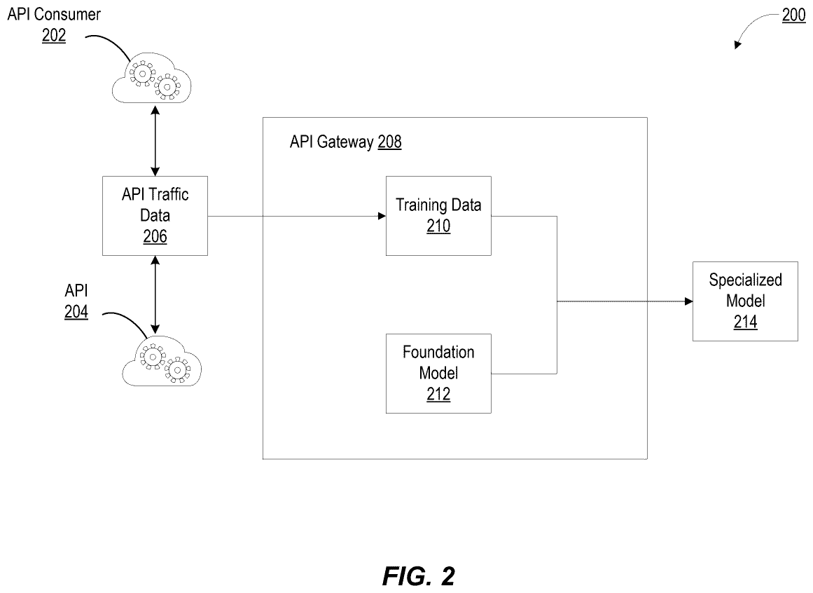

FIG. 2 is a block diagram 200 illustrating training the model using API traffic, according to an embodiment of the disclosed technology.

The interaction between the API consumer 202 and the API 204 generates API traffic data 206. In some embodiments, the API consumer's 202 actions (e.g., a request) trigger returning communication with the API 204 (e.g., a response). The API 204 receives incoming requests from the API consumer 202 and responds accordingly by providing a meaningful answer to the API consumer's 202 request. For example, a request for a “Name” returns a corresponding response “John.”

The API traffic data 206 includes details such as request parameters, response payloads, status codes, timestamps, and other relevant metadata. The request is, in some embodiments, structured messages containing parameters, headers, and/or payload data relevant to the intended operation. Upon receiving a request from the API consumer 202, the API 204 processes the incoming message, interpreting the communication's contents and executing the necessary operations to generate a meaningful response. The response is, in some embodiments, the outcome from the API of the requested operation or the information requested by the API consumer 202.

The API gateway 208 intercepts and manages the flow of API traffic between the API consumer 202 and the API 204. The API gateway 208, in some embodiments, serves multiple functions, such as request routing, authentication, rate limiting, and/or logging. The API gateway 208 intercepts API traffic data 206 to enable generating the training data 210 for generating a specialized model.

In some embodiments, while observing and intercepting the API traffic data 206, the API gateway 208 monitors and analyzes various performance metrics such as request frequency, latency, and/or error rates to dynamically adjust the API gateway's 208 rate limiting policies to maintain service availability under varying load conditions. For example, monitoring request frequencies helps the API gateway 208 gauge the rate at which incoming requests are being received by the API gateway 208 and allows the API gateway 208 to anticipate and dynamically adapt to fluctuations in demand. Latency metrics provide information about the responsiveness of the system, indicating whether requests are being processed efficiently or if there are delays that need to be addressed by modifying the API gateway's operations. Similarly, error rates signal the occurrence of issues such as server errors, network problems, or invalid requests.

The training data 210 is generated from the API traffic data 206 and serves as the input for training the AI model. The training data 210, in some embodiments, includes a subset of API traffic data that is selected based on specific criteria or requirements (e.g., has to be payment-related information). The training data 210 encapsulates the patterns, trends, and behaviors exhibited within the API traffic data 206 and provides the input upon which the specialized model learns to make predictions and derive insights for the specific service within the microservice application.

A foundation model 212 provides an initial baseline upon which the specialized model is generated. For example, the foundation model 212 consists of pre-existing models, algorithms, and/or other predictive methodologies fit to analyze the service's API traffic. The foundation model provides the initial structure and guidance for the AI model during the training process, directing the AI model to generate the underlying patterns and dynamics identified in the API traffic data. While training the AI model, the foundation model 212 serves as a beginning reference point. Through a process of iterative refinement, the system progressively refines the foundation model 212 to generate a specialized model 214. In some embodiments, the foundation model 212 includes domain-related knowledge (e.g., payment information), from previous API traffic and/or external databases. For example, in a payment API context, the foundation model 212 integrates external data sources such as industry reports, regulatory guidelines, and/or fraud detection databases, to supplement the model's understanding of payment-related operations.

In some embodiments, the foundation model 212 is a Large Language Model (LLM) or a generative AI model able to understand and generate human-like text. Large language models (“LLMs”) (e.g., ChatGPT) are trained using large datasets to enable them to perform natural language processing (“NLP”) tasks such as recognizing, translating, predicting, or generating text or other content. In some embodiments, the foundation model 212 makes use of a natural language chat interface for humans to make requests to the AI. The training data specific to the microservice application APIs creates supplemental or specialized models that enhance the foundation model's understanding within the specific context of the application. By using training data derived from API traffic, the specialized model better interprets and responds to commands (e.g., queries) related to the microservice architecture, rather than only having a general understanding of the foundation model 212. The iterative training process allows the specialized model to learn from the patterns and relationships present in the API traffic, enabling the specialized model to make more accurate predictions and generate contextually relevant responses.

After iterative training using the training data 210, the AI model is specialized, and results in a specialized model 214. The specialized model 214 includes predictive capabilities and/or actionable insights on the API traffic data 206. The specialized model 214, in some embodiments, learns to discern patterns, anomalies, and correlations within the API traffic data 206, which then enables the specialized model 214 to make informed predictions, take autonomous actions, and/or generate recommendations for modifying the API traffic data. In some embodiments, the specialized model 214 is able to be deployed on future API traffic. For example, in the context of a payment API where the user of the gateway would like to detect potential fraud, the specialized model 214 can, in real-time, block the payments that the model 214 detects potential fraud in. The user instructs the API gateway 208 to interpret the intercepted API traffic using the specialized model 214 and further moderate the API traffic by “blocking payments for every user that has already experienced three payment declines in the last hour.” The API gateway 208 then uses the specialized model 214 to identify users that have experienced three or greater payment declines in the last hour and proceeds to block the payments, as instructed by the user.

In some embodiments, the specialized model 214 predicts the operations of the application (e.g., the API traffic that is supposed to occur during normal application operations). If the predicted operations of the application do not match with the actual operation of the application, the specialized model 214 implements, in some embodiments, modification measures to adjust the API traffic to remedy any detected errors. For example, if a user-submitted form is missing a field, the specialized model 214 identifies the anomaly or other predefined event and recommends and/or implements a modification to fix the error.

In some embodiments, the specialized model 214 autonomously implements preventative measures. For example, the specialized model 214 identifies a recurring pattern where users tend to abandon the user's online shopping carts after encountering a specific error message during the checkout process. Based on the insight, the API gateway 208 recommends adjustments to the service, such as modifying certain error handling mechanisms or providing clearer instructions to users to reduce cart abandonment rates. Alternatively, the API gateway 208 automatically adjusts the service using the output of the specialized model 214.

In some embodiments, the specialized model 214 identifies anomalies or other predefined events in the API traffic data 206, such as unusually high traffic spikes and/or suspicious user behavior indicative of potential security threats. In response, the API gateway 208 triggers automated actions to mitigate these anomalies, such as implementing rate limiting and/or blocking suspicious IP addresses to enhance the security and reliability of the service.

In some embodiments, the specialized model 214 is structured to further provide an output in response to user command sets (e.g., queries). For example, the API gateway 208 is designed to use prompt engineering to transform the user's command set before inputting the command set into the specialized model 214. In some embodiments, user queries are handled differently by the foundation model 212 and the subsequently generated specialized model 214. Natural language processing (NLP) or general queries are processed by the foundation model 212 (e.g., an LLM or a generative AI model). The models, such as OpenAI's GPT (Generative Pre-trained Transformer) series or Google's BERT (Bidirectional Encoder Representations from Transformers), are pre-trained on large corpora of text data to capture linguistic patterns and semantic relationships. Once the query is interpreted and understood by the foundation model 212, the supplemental domain-specific knowledge on the specific application is applied to execute the command set, using insights identified from the training data 210 associated with the service's APIs.

Prompt engineering is a process of structuring text that is able to be interpreted by a generative AI model. For example, in some embodiments, a prompt (e.g., command set) includes the following elements: instruction, context, input data, and an output specification. Although a prompt is a natural-language entity, a number of prompt engineering strategies help structure the prompt in a way that improves the quality of output. For example, in the prompt “Please generate an image of a bear on a bicycle for a children's book illustration,” “generate,” is the instruction, “for a children's book illustration” is the context, “bears on a bicycle” is the input data, and “an image” is the output specification. The techniques include being precise, specifying context, specifying output parameters, specifying target knowledge domain, and so forth.

Automatic prompt engineering techniques have the ability to, for example, include using a trained large language model (LLM) to generate a plurality of candidate prompts, automatically score the candidates, and select the top candidates. In some embodiments, prompt engineering includes the automation of a target process-for instance, a prompt causes a trained model to generate computer code, call functions in an API, and so forth. Additionally, in some embodiments, prompt engineering includes automation of the prompt engineering process itself-for example, an automatically generated sequence of cascading prompts, in some embodiments, include sequences of prompts that use tokens from trained model outputs as further instructions, context, inputs, or output specifications for downstream trained models. In some embodiments, prompt engineering includes training techniques for LLMs that generate prompts (e.g., chain-of-thought prompting) and improve cost control (e.g., dynamically setting stop sequences to manage the number of automatically generated candidate prompts, dynamically tuning parameters of prompt generation models or downstream models).

Models integrated directly into the gateway or existing AI APIs often incur different costs compared to separate, locally stored models, which correlates with the degree of reliance on pre-trained models versus models trained specifically for the local environment. For example, AI model API pricing structures often revolve around a cost-per-symbol or a cost-per-processing operation basis. The pricing varies significantly depending on factors such as the extent of pre-trained models used versus locally trained models, with the former often commanding higher costs due to the resources involved in the development and maintenance.

In some embodiments, the AI model is embedded directly within the API gateway itself, meaning that the processing and decision-making occur at the point where API traffic enters or exits the system. By deploying models in the gateway, not only can organizations keep lower costs, but organizations can also enforce organization-specific policies, perform authentication, and apply AI-driven transformations or filtering to incoming or outgoing requests.

In some embodiments, the AI models are components of an existing AI API infrastructure (e.g., GPT, Mistral, Llama). The AI APIs offer pre-trained models and APIs for performing various natural language processing (NLP) tasks, sentiment analysis, and/or custom machine learning tasks. By using the APIs, though costs may be higher, developers offload complex AI tasks to specialized services, which reduces the development effort and allows organizations to benefit from ongoing updates and improvements to the underlying models.

In some embodiments, the AI models are implemented as standalone components separate from existing AI frameworks. The models are stored locally within the microservice architecture. The approach provides greater flexibility and control over model development, deployment, and versioning. Additionally, organizations are able to tailor the AI model specifically to their application's requirements and integrate them into the organization's existing infrastructure. In some embodiments, the separate AI model operates autonomously without any direct interface with existing models. The AI model performs the tasks independently, which is useful when requirements are distinct and there's no need for interaction with other models. Alternatively, the separate AI model has an interface with existing models which allows for collaboration and data exchange between them. The interface allows the AI model to use insights and predictions generated by existing models. A handler (e.g., a communication interface) is implemented to facilitate the exchange of data and commands between the AI model and other components or services within the microservice architecture application.

In some embodiments, the AI models are entirely independent of existing frameworks like GPT, Mistral, or Llama. Costs are lower, and the approach allows for complete customization and control over the model architecture, training data, and algorithms used. Organizations are able to address specific business challenges with the AI model tailored to the organization's unique requirements.

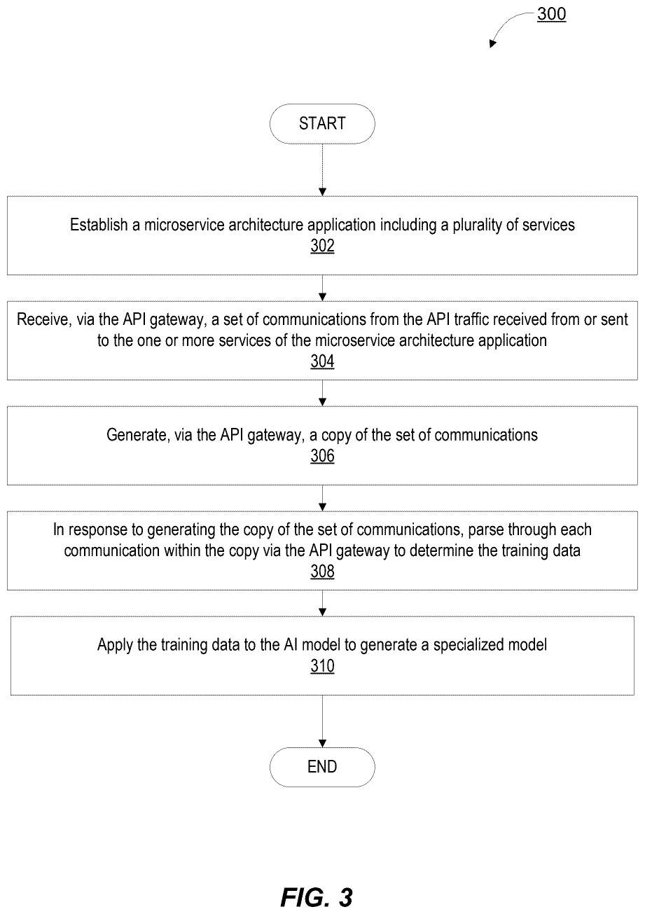

FIG. 3 is a flowchart 300 illustrating a method for training an AI model using existing API traffic, according to an embodiment of the disclosed technology.

At step 302, the API gateway establishes a microservice architecture application including multiple services. Each service performs a piecemeal function of an overall application function. In some embodiments, one or more services are associated with API traffic of the services to an API gateway. A microservice architecture application allows the individual services within to develop, deploy, and scale autonomously without impacting other parts of the application.

The API gateway is configured to observe and copy the API traffic of one or more services. The API gateway identifies the API traffic data such as the headers, parameters, and/or payloads, from each packet and reconstructs the packet into a new packet structure. In some embodiments, the copies are stored in a dedicated data repository hosted on cloud infrastructure, such as Amazon Web Services (AWS) S3 buckets, Google Cloud Storage, or Azure Blob Storage. The cloud-based storage solutions offer high availability, durability, and scalability and allow the API gateway 208 to securely store large volumes of communication data. In some embodiments, the copies are stored in local servers to retain fuller control of the data for reasons such as security concerns.

In some embodiments, the API gateway 106 employs buffering and queuing mechanisms to manage the flow of intercepted packets effectively. By buffering incoming packets temporarily, the gateway can ensure that no API traffic data is missed during periods of high traffic volume. For example, queuing mechanisms prioritize the processing of packets based on predefined criteria, such as packet type or source, to improve resource utilization and minimize latency.

At step 304, the API gateway receives a set of communications from the API traffic received from or sent to one or more services of the microservice architecture application. In some embodiments, the API traffic includes request headers, response headers, payload content, connection information, security information, operational data, and/or performance metrics. For further details, see FIG. 1.

Request headers contain metadata and contextual information about the incoming requests made to the services. The headers include, for example, details such as the type of request, content type, authorization tokens, and/or any parameters relevant to the communication. Response headers include details regarding the response status, content type, caching directives, and/or any other metadata pertinent to the returned data.

In some embodiments, the API traffic incorporates payload content, which includes the actual data transmitted between the services and the API. For example, the payload content is presented in structured data formats such as JSON or XML, binary data, textual content, and/or any other data representation employed by the services.

In some embodiments, operational data and performance metrics include metadata about the operational health, efficiency, and/or reliability of the microservices. For example, the metrics encompass latency, throughput, error rates, and/or resource utilization of the corresponding service.

At step 306, in some embodiments, the API gateway generates a copy of the communications. The copy of the communications is categorized, in some embodiments, based on variables indicative of a particular attribute across the copy of the communications. In some embodiments, the API gateway observes and copies the API traffic of the services using a session layer (L5), a presentation layer (L6), and/or an application layer (L7) of an Open Systems Interconnection (OSI) model.

In some embodiments, the categorization identifies and isolates attributes or parameters within the communications dataset that exhibit consistent patterns or variations. The attributes encompass factors such as specific request parameters, response characteristics, temporal variables, traffic packet size, and/or contextual variables inherent in the communication. For example, variables indicate the type of API accessed, the frequency of requests, the response status codes, and/or the presence of certain keywords or data patterns within the payloads.

The API gateway is designed to train an AI model to generate a specialized model using, at least, a portion of the communications between the API and the API consumer as training data. The AI model captures patterns or behaviors associated with one or more services in the microservice application.

At step 308, in response to generating the copy of the communications, the API gateway parses through each communication within the copy to determine the training data. The parsing process involves analyzing the structure and content of both requests and responses to extract information relevant to training the AI model. Training data for requests include attributes such as traffic packet size, endpoint paths, HTTP methods, request parameters, authentication tokens, and/or other relevant metadata. Similarly, for responses, the training data includes traffic packet size, status codes, response headers, payload content, and/or other relevant metadata. In some embodiments, the training data includes the frequency and/or speed at which the communications are received from or sent to the services. By capturing metrics such as request frequency, response times, and data transfer rates, the model is able to learn the dynamic nature of the API interactions.

In some embodiments, the training data of a request within the copy of the communications includes a corresponding title of the particular attribute, and/or the training data of a response within the copy of the communications includes an answer to the title of the particular attribute for the corresponding request. Including the information in the training data allows the model to organize and structure the given training data to learn the underlying semantics and context associated with each attribute.

In some embodiments, the training data is a subset of the intercepted API traffic. For example, the training data is generated by filtering the intercepted API traffic based on predefined parameters. The filtering mechanism enables users to tailor the training data to specific scenarios or conditions, focusing on relevant subsets of communications while disregarding noise or irrelevant data points. For example, for a user that would like to focus on financial transactions, the filters that are used on API traffic are specifically associated with financial transactions, such as “/transactions,” “/payments,” and “/balances,” to focus on fund transfers, bill payments, balance inquiries, and transaction history retrieval.

In some embodiments, the training data is the entire intercepted and/or copied API traffic. Using the entire dataset ensures that the AI model is specialized on an unbiased representation of the system's activities by preventing cherry-picking specific subsets of data, which inadvertently introduces biases or overlooks crucial patterns present in less frequently occurring transactions.

At step 310, the API gateway applies the training data to the AI model to generate a specialized model that captures the patterns or behaviors associated with one or more services using the training data. The specialized model, in some embodiments, is generated on top of a foundation model that includes base parameters associated with the communications associated with the API traffic. For further details regarding the foundation model, see FIG. 2.

In some embodiments, throughout the training process, the API gateway monitors and evaluates the performance of the AI model to ensure that the model effectively captures the underlying patterns and behaviors associated with the services within the microservice architecture. The continual feedback loop enables the API gateway to fine-tune the training process and iteratively refine the specialized model using new API traffic and previous performance metrics.

In some embodiments, the API gateway determines a variable using semantic analysis based on a particular response of the API traffic for a corresponding request of the API traffic, where the semantic analysis infers the corresponding title for the variable based on the answer to the corresponding title of the variable. In some embodiments, semantic analysis uses natural language processing (NLP) and deep learning to analyze the content, syntax, and semantics of the communications to identify relevant variables and attributes embedded within the API traffic. By analyzing the responses received from the API for specific requests, the API gateway infers the semantic meaning and relevance of the information conveyed within the responses. For example, when processing a response within the API traffic, the API gateway identifies, within the response, key entities, attributes, or data points relevant to the underlying business logic or domain context. Then, the API gateway infers corresponding titles or labels that accurately reflect their semantic meaning and purpose within the API traffic data.

The specialized model, in some embodiments, identifies any anomalies or other predefined events in the communications and modifies API traffic for the corresponding communication to, for example, correct the anomaly. For example, an anomaly occurs when the predicted result of the model does not match the communication (e.g., a request is missing a certain field that the model predicts should be there). In some embodiments, modifying the communication causes the API gateway to discard the communication. Further, in some embodiments, the specialized model is stored in a cloud environment hosted by a cloud provider with scalable resources or a self-hosted environment hosted by a local server. For further details, see FIG. 2.

In some embodiments, there are multiple gateways. For example, a second gateway associated includes a second API traffic of the services to the second gateway, and the second gateway also observes the second API traffic of the services. The second gateway intercepts the second API traffic received from or sent to the services of the microservice architecture application. Similar to the first gateway, the second gateway parses through the communications within the intercepted second API traffic to determine new training data. The second gateway can then also direct the specialized model, along with the first gateway, based on the new training data.

In some embodiments, the API gateway receives feedback on the specialized model related to the performance metrics of the specialized model when implemented on the API traffic. The API gateway, in response to the metrics, dynamically adjusts the parameters of the specialized model based on the received feedback. In some embodiments, the API gateway monitors or generates performance metrics itself, when implemented on the API traffic, and iteratively refines the specialized model based on the monitored performance metrics.

In some embodiments, the API gateway is continuously observing and refining the specialized model. In some embodiments, the duration of training for the AI model is adjustable by users of the API gateway, where training the AI model terminates upon reaching the duration.

In some embodiments, a traffic selection module provides options for users of the API gateway to specify filtering criteria for generating the training data. For example, users have the choice to filter the API traffic based on criteria such as the type of API, the HTTP method used (e.g., GET, POST, PUT, DELETE), specific request or response headers, payload content types, payload size, status codes, timestamps, and/or any other relevant metadata associated with the communications exchanged between the API and the API consumer.

In some embodiments, the traffic selection module offers more specific filtering options, that allow users to employ logic-based filters and conditions to refine the selection of API traffic data. For example, the traffic selection module includes the ability to specify logical operators, regular expressions, or custom rules to identify and extract subsets of API traffic that meet specific criteria or exhibit certain patterns or behaviors of interest. In some embodiments, the user inputs a query (e.g., command) to define the criteria for filtering the training data and/or specify other parameters. For example, the user requests to “only train on the “/payments” endpoint and only if the response returns “200 OK.”

In some embodiments, the traffic selection module supports dynamic filtering capabilities to enable users to define filtering criteria that adapt and evolve over time based on changing requirements or evolving patterns within the API traffic. The dynamic filtering functionality ensures that the training data remains relevant and up-to-date. For example, an e-commerce platform experiences fluctuating traffic patterns throughout the day, with peak usage occurring during certain hours and lulls during others. During peak hours, the API gateway prioritizes training data collection from API traffic related to high-demand product categories. As traffic patterns shift throughout the day, the filtering criteria change dynamically to capture data from emerging trends or seasonal variations. For instance, when a new product launch generates significant interest among users, the dynamic filtering capabilities enable the platform to adapt by adjusting the criteria to target API traffic related to the new product. In some embodiments, the dynamic filtering functionality automatically adjusts the filtering criteria based on predefined thresholds or triggers. For example, if the platform detects a sudden surge in traffic or an unexpected change in user behavior, the platform triggers the traffic selection module to refine the filtering criteria to focus on capturing data relevant to the changing situation.

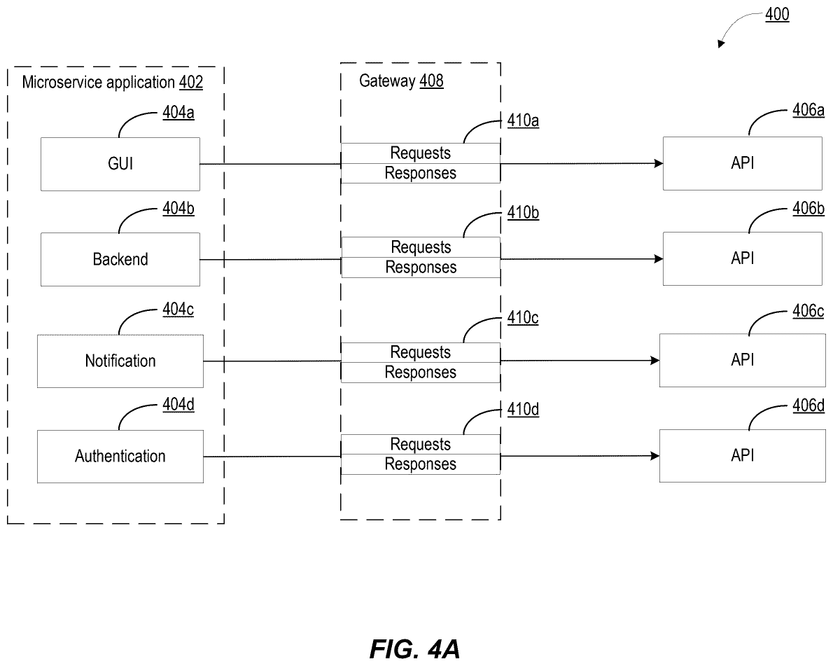

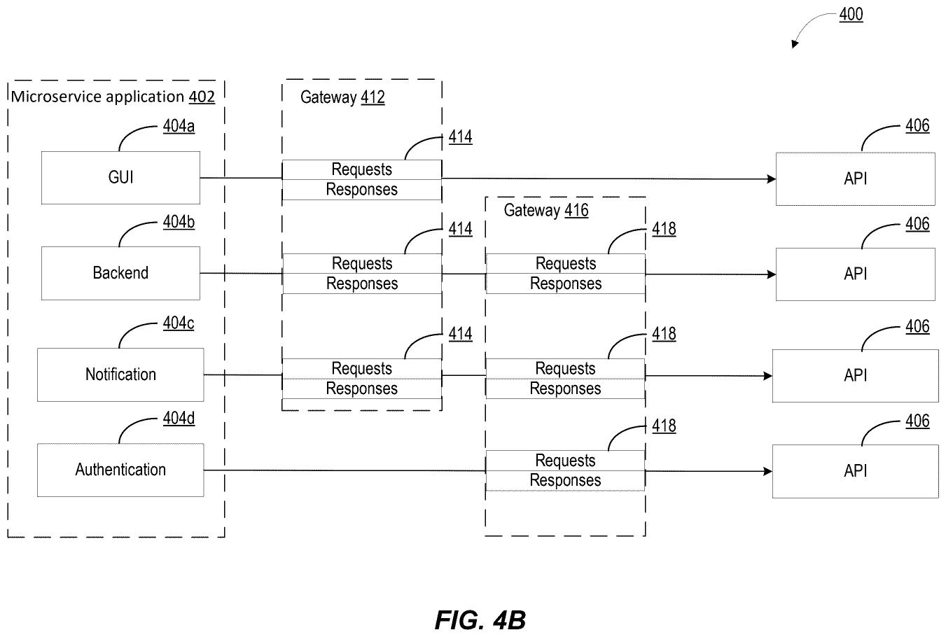

FIG. 4A is a block diagram 400 illustrating a microservice architecture application with an API gateway as an endpoint, according to an embodiment of the disclosed technology.

The microservice architecture application 402 is structured around a decentralized model, with individual services 404 representing discrete functional services or units (e.g., GUI service 404a, backend service 404b, notification service 404c, authentication service 404d). Each service 404 is designed to execute specific tasks independently within the overall system. The services 404 expose APIs 406a-d that allow the services 404 to interact with each other and external entities. For example, the services include a GUI service 404a for presenting information to users, a backend service 404b for handling data processing and storage, a notification service 404c for managing communication with users, and an authentication service 404d for ensuring secure access to the application.

The services 404 operate independently within the microservice architecture, which allows for scalability and flexibility. Each service is designed to perform specific tasks without dependencies on other services. For example, updates or changes to one service can be implemented without affecting the functionality of other services.

The API gateway 408 is a centralized entry point for incoming and outgoing API traffic 410 within the microservice application 402. The API gateway 408 intercepts the API traffic 410 and outputs a specialized model. API traffic 410 represents the flow of data between the services 404 and APIs 406, which includes the requests and responses exchanged between the services 404 and APIs 406. The API traffic 410 encompasses a wide range of interactions, including user requests, data retrieval, and/or system updates.

FIG. 4B is a block diagram 400 illustrating a microservice architecture application with multiple API gateways, according to an embodiment of the disclosed technology.

In some embodiments, a second API gateway 412 operates in parallel with the primary gateway to handle a new set of the API traffic 414. In some embodiments, the second API gateway 412 directs, along with a third gateway 416 that handles API traffic 418, to train the AI model by providing different training data. By dividing the API traffic from the services 404a-c between multiple gateways (e.g., second API gateway 412 and third API gateway 416), the system achieves better scalability, fault tolerance, and performance by lightening the traffic load on each gateway. For the shared services (e.g., backend service 404b and notification service 404c in FIG. 4B), in the event of a failure or downtime in one gateway, the other gateway continues to process the assigned traffic.

In some embodiments, each gateway independently manages an assigned subset of traffic. By independently managing the gateway's assigned subsets of traffic, each gateway can better allocate the gateway's processing resources and prioritize tasks based on the characteristics and requirements of the specific traffic subset.

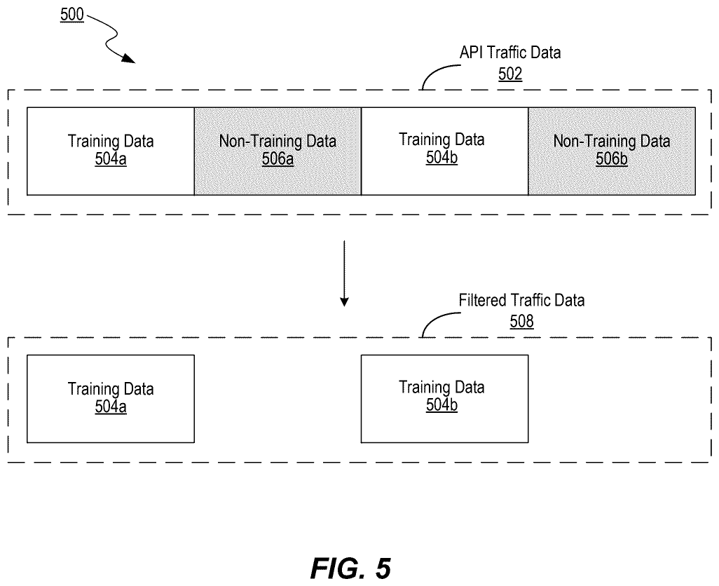

FIG. 5 is a block diagram 500 illustrating components and associated steps involved in generating training data from the existing API traffic, according to an embodiment of the disclosed technology.

In some embodiments, the API traffic data 502 includes both training data, 504a and 504b, and non-training data, 506a and 506b. In some embodiments, training data 504 includes request-response pairs, metadata, contextual information, and/or other relevant attributes that characterize API interactions of the service. In contrast, in some embodiments, non-training data 506 includes API traffic that is not utilized for training purposes. For example, the API traffic data for an e-commerce platform. Training data includes instances of successful and failed authentication attempts, different types of product queries, and various stages of the checkout process. Meanwhile, the non-training data includes the remaining API traffic that is not utilized for training purposes, including routine API calls for system monitoring, logging, and/or administrative purposes.

In some embodiments, the API gateway employs a content analysis mechanism to discern between the two categories, recognizing specific patterns, keywords, or formats indicative of whether or not the data is training data 504.

In some embodiments, non-training data 506 is data that is indicative of sensitive information. In some embodiments, the list of indicators of sensitive information is generated by a generative AI model (e.g., with a command set that resembles “generate a plurality of examples of PII”). The generative AI model is specialized via training on a dataset containing examples of sensitive data elements, such as personally identifiable information (PII), financial records, or other confidential information. Once the AI model has been specialized, the AI model generates indicators (e.g., specific patterns, keywords, or formats) of sensitive information based on the model's learned associations.

Once generated, the list of indicators enables heuristic comparisons and/or evaluations via comparatively simple, non-generative AI models to the list of indicators and potential PII dataset. By using a generative AI model to generate a list of indicators but then not employing the generative AI to perform the actual comparisons, no generative AI is able to train on the potential PII data.

In some embodiments, through the utilization of pre-trained models and contextual analysis, the API gateway identifies specific patterns, keywords, or formats that serve as indicators of sensitive information. In some embodiments, the content analysis mechanism operates in real-time, dynamically adjusting the recognition criteria based on evolving patterns and emerging threat vectors. Semantic meaning is extracted from the user input, which allows the gateway to categorize information based on contextual relevance and potential sensitivity. For instance, the mechanism recognizes patterns associated with personally identifiable information (PII), sensitive keywords, or predefined data formats aligning with confidential information. The analysis enables the API gateway to make informed decisions about the nature of the content.

For instance, within the context of a service focused on customer support, the API gateway employs pattern recognition to identify keywords or phrases indicative of sensitive information. If API traffic includes “/password,” “/username,” and “/email,” the API gateway detects keywords such as “password.” Recognizing these patterns, the API gateway understands that the traffic is related to PII and categorizes “/password” as non-training data 506.

Upon the completion of the analysis, the system generates the filtered traffic data 508, which exclusively retains the non-sensitive input components. The filtered traffic data 508, therefore, effectively removes any sensitive data, ensuring that only permissible and non-sensitive elements persist in the subsequent processing stages. In the example above, the filtered traffic data 508 includes “/username” and “/email,” but not “/password.” The sanitization process upholds data privacy and compliance with security protocols. In some embodiments, a combination of any of the described modifications is implemented.

In some embodiments, a list of indicators of training-related information is provided to the API gateway. The indicators encompass, for example, patterns, keywords, or formats commonly associated with training data, such as specific payload structures. For example, indicators for a finance application include keywords like “payment,” “transaction,” or “user authentication,” which are typically associated with training data related to financial transactions.

In some embodiments, the training-related information is generated by an AI model (e.g., with a command set that resembles “generate a plurality of indicators for payment information”). The AI model is generated on a dataset containing examples of training-related data elements from previous API traffic and/or external datasets. Once the AI model has been specialized, the AI model generates indicators (e.g., specific patterns, keywords, or formats) of training-related information based on the model's learned associations. The indicators serve as predictive cues that direct the API gateway in identifying and categorizing incoming API traffic into the appropriate categories of training and non-training data. The system then generates filtered traffic data 508, which exclusively retains the training data components, 504a and 504b. The filtered traffic data 508, therefore, effectively removes any non-training data, ensuring that only needed training-related elements persist in the subsequent processing stages.

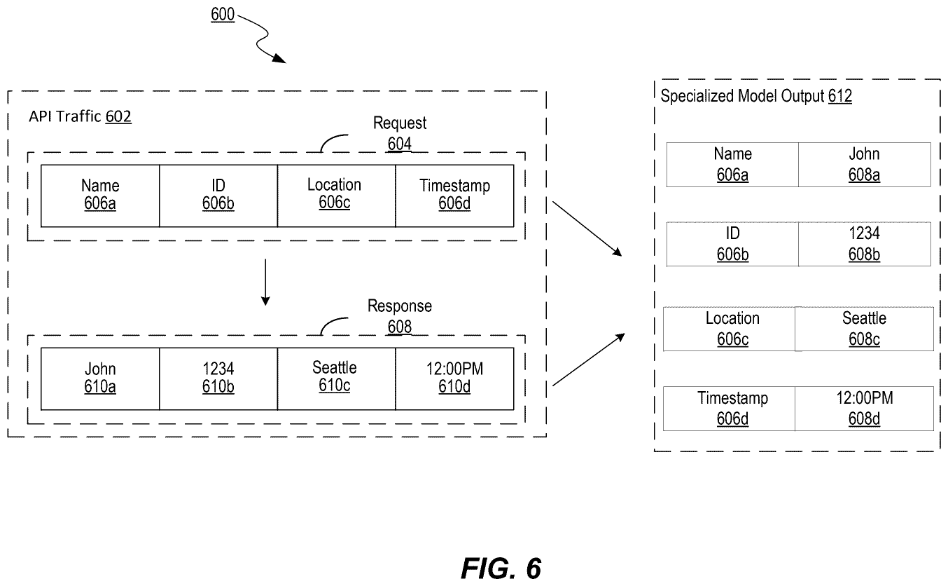

FIG. 6 is a block diagram 600 illustrating categorizing the existing API traffic by variables, according to an embodiment of the disclosed technology.

The API traffic 602 includes requests 604 and responses 608 exchanged between APIs and services within the microservice architecture. Each request 604 and response 608 contain request 606 variables and response 610 variables, respectively.

Request variables 606a-d encompass attributes extracted from incoming requests, such as headers, query parameters, payload content, and any other relevant information. In some embodiments, request variables 606a-d serve as indicators of the service's intent. Similarly, response variables 610a-d encapsulate data extracted from outgoing responses, including status codes, payload content, and metadata associated with the server's behavior.

To categorize the existing API traffic 602 by variables, the specialized model analyzes each request and response captured. The analysis involves parsing the inbound and outbound messages to extract relevant variables and the variable's corresponding values. The variables are then organized and categorized based on predefined criteria, such as the variables' semantic meaning, frequency of occurrence, or relevance to specific business processes.

The categorized variables form the basis of the specialized model's output 612. By associating each request and response with the corresponding set of variables, the specialized model's output 612 captures the nuances and patterns present in the API traffic 602.

In some embodiments, the specialized model predicts the title of a variable (e.g., “Name,” “ID,” “Location,” “Timestamp”) based on the response data. The specialized model analyzes the content of the response 608 to identify recurring patterns and structures. For instance, the specialized model recognizes common phrases or terms that typically represent certain types of information, such as product names or prices. By understanding the semantics of the response data, the specialized model infers the purpose or meaning of different elements within the response. In some embodiments, the model considers the context of the response within the overall transaction flow. For example, if the response 608 follows a request 606 to retrieve product information, the model predicts that certain elements within the response 608 correspond to attributes of the product. By analyzing the sequence and context of API interactions, the model can make more accurate predictions about the titles of variables based on the content of the response 608.

In some embodiments, to infer the request based on the response, the response data is first preprocessed to clean and tokenize the text, removing noise and irrelevant information. For example, the text is segmented into individual tokens (words or subwords), to normalize the text. Then, various features are extracted from the response data to capture the feature's semantic and/or syntactic properties. For example, the AI model identifies n-grams (sequences of adjacent words), part-of-speech tags, syntactic dependencies, and named entities. The identified features are then transformed to generate meaningful representations of the context. For example, textual features are converted into numerical representations using methods such as word embeddings (e.g., Word2Vec, GloVe) or contextual embeddings (e.g., BERT, RoBERTa).

In some embodiments, a machine learning model is generated using the preprocessed response data and identified features. In some embodiments, the AI model is generated on a previous set of API traffic between the service and the API of labeled responses, where the titles of variables are known. By learning from the data, the model identifies correlations between specific phrases or patterns in the response 608 text and the corresponding variable titles. The model learns to predict variable titles based on the input features and contextual relationships. The specialized model is fine-tuned (e.g., using gradient descent optimization and regularization) to improve the model's performance and generalization capabilities. For example, the specialized model is evaluated using validation datasets to assess the mode's performance metrics such as accuracy, precision, recall, and F1-score. Cross-validation techniques, in some embodiments, are used to prevent overfitting.

Once the model achieves satisfactory performance on the validation data, the model is deployed in a production environment where the model is used to predict variable titles dynamically as the API traffic passes through the API gateway. In some embodiments, the specialized model is continuously monitored to track the model's performance and detect any degradation or drift over time. Regular updates and retraining cycles can be scheduled to ensure the model remains accurate and up-to-date with evolving data patterns and requirements.

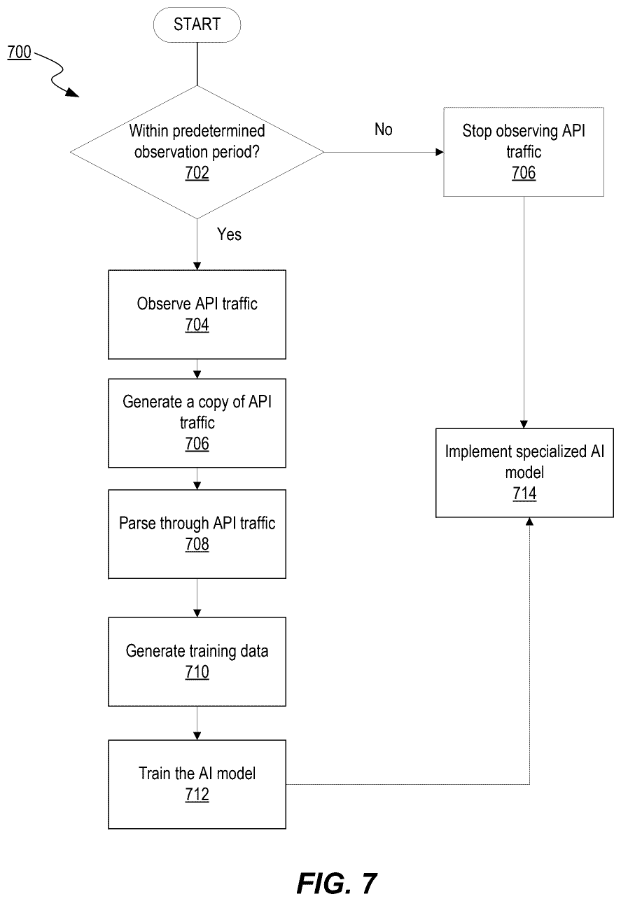

FIG. 7 is a block diagram 700 illustrating observing the API traffic for a predetermined observation period, according to an embodiment of the disclosed technology.

In some embodiments, the API gateway first, in step 702, determines whether the current time falls within a predefined observation period. For example, the API gateway queries a system clock or a predefined scheduling mechanism. In some embodiments, the API gateway logs events related to observation initiation and completion, sends notifications to system administrators, and/or triggers automated workflows for further processing of observed data.

The period, for example, is specified in various units of time such as minutes, hours, or days, and defines the duration during which the gateway will actively observe API traffic for training purposes. If the API gateway confirms that the time is within the designated observation period, the API gateway proceeds to observe the API traffic in step 704. Observing involves the systematic monitoring of incoming and outgoing data packets, requests, and/or responses exchanged between the API endpoints. In some embodiments, the API gateway utilizes network monitoring tools or custom-built software components to capture and analyze the API traffic effectively. During the observation phase, the API gateway generates a copy of the observed API traffic in step 706 and continuously monitors incoming API traffic in real-time to capture relevant data and interactions between API consumers and providers.

Once the API traffic is captured and duplicated, the API gateway proceeds to parse through the copied data in step 708. Parsing involves identifying pertinent information from the API requests and responses for training an AI model, such as headers, parameters, payloads, and metadata.

The API gateway generates training data for the AI model in step 710. In some embodiments, the training data is a structured dataset derived from the parsed API traffic, containing features, labels, and other relevant attributes necessary for training the model.

Subsequently, the API gateway trains the AI model using the generated training data in step 712. In some embodiments, the training phase involves feeding the training data into the machine learning algorithms, which iteratively learn from the data to identify patterns, correlations, and predictive insights embedded within the API traffic.

Upon the expiration of a predefined observation period and/or the occurrence of a predetermined event trigger, the API gateway, in step 714 implements the specialized AI model by integrating the specialized model into the API traffic, where the API gateway can actively analyze incoming API traffic in real-time, providing valuable insights, predictions, and/or automated actions based on the model's learned behavior and predictions.

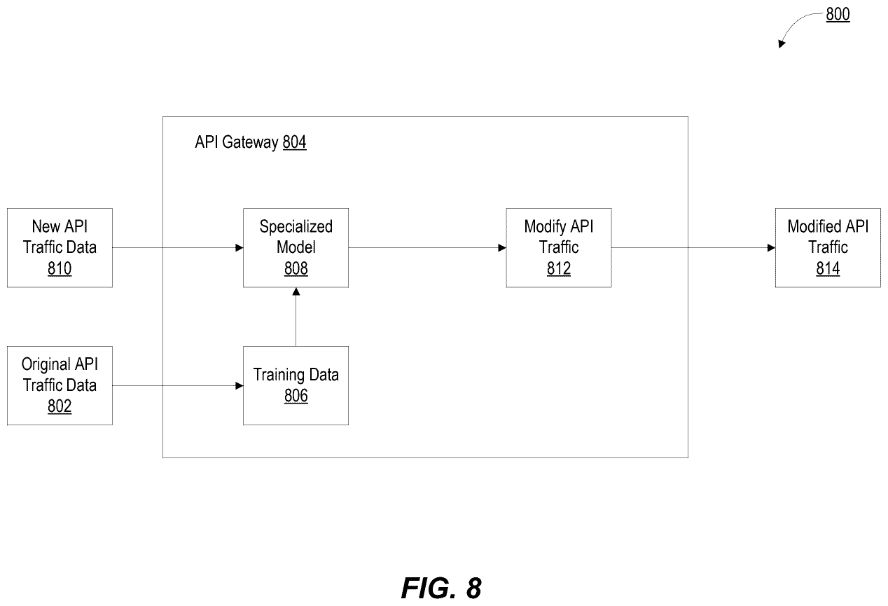

FIG. 8 is a block diagram 800 illustrating modifying new API traffic using the specialized model, according to an embodiment of the disclosed technology.

The original API traffic data 802, or data that was used for training a model to recognize normal patterns and behaviors in API traffic, is intercepted by the API gateway 804. Once the original API traffic data 802 is collected, the original API traffic data 802 is used to generate training data 806. The training data 806, in some embodiments, consists of labeled examples of API interactions, including both normal and anomalous patterns. Using the training data 806, a machine learning model is generated to identify anomalies or other predefined events in real-time API traffic.

The specialized model 808, in some embodiments, applies anomaly detection algorithms to new API traffic data 810. New API traffic data 810, in some embodiments, is the current stream of API requests and responses flowing through the system. As the new API traffic data 810 passes through the API gateway 804, the specialized model 808 analyzes each interaction to detect any deviations from normal behavior. When anomalies are detected, the API gateway 804, in some embodiments, modifies the API traffic 812 data. Modifying the API traffic 812 involves taking corrective actions to address the detected issues. For example, the API gateway 804 modifies the incoming or outgoing API requests or responses dynamically to correct the anomalies detected by the specialized model 808 to mitigate potential risks or prevent service disruptions. For example, a communication that corresponds to “Name” with an incorrect spelling is intercepted. The API gateway 804 modifies the name to the predicted correct spelling before allowing the communication to continue. The modified API traffic 814 then, free of anomalies, continues to flow to the destination (e.g., API, service). By dynamically adapting to changes in API traffic and proactively addressing anomalies, the API gateway 804 maintains the reliability, security, and/or performance of the API and/or the service.

For example, the specialized model 808 detects, through the API traffic, unusually rapid addition of high-value items to the shopping cart, frequent changes in shipping addresses and payment methods, and minimal engagement with product details. Through semantic analysis and pattern recognition applied to the API traffic data, the specialized model 808 identifies the behaviors as potential indicators of fraudulent activity. In some embodiments, the specialized model generates a weight for detected anomalies in the communication. If the weight crosses a predetermined threshold, the specialized model 808 flags the communication for the API gateway to determine further actions.

In some embodiments, modifying the API traffic 812 includes one or more of the following as applied to the API traffic 812: appending, prepending, discarding, allowing, sanitizing, anonymizing, and modifying. Modifying the API traffic 812, in some embodiments, only modifies a portion of the API traffic 812. Modifying the API traffic 812, in some embodiments, involves manipulations of the input based on the prescribed actions, such as anonymization of sensitive information or syntactic restructuring.

In some embodiments, modifying the API traffic 812 includes altering the user input, such as but not limited to: appending, prepending, removing, or adding content within the user input. For example, API traffic 812 includes “PIN number:” “1234,” where the PIN number is sensitive information. To address the sensitive information, the API gateway 804 modifies the API traffic 812 by applying the parameter, resulting in transformed traffic: “PIN number:” “XXXX.” The modified input preserves the user's intent while safeguarding sensitive information.

In some embodiments, modifying the API traffic 812 is guided by a prioritization system. Modifying the API traffic 812, in some embodiments, includes a plurality of actions, which are prioritized based on predefined priority parameters. The predefined priority parameters, in some embodiments, involve factors such as security risk, compliance requirements, or strategic importance. The model yields a prioritized set of actions, where each action is assigned a specific priority level. For example, a set of actions including ones pertaining to security measures and performance improvements can be prioritized so that security measures have a higher priority.

For example, a client requests order confirmation details from an e-commerce platform. The API traffic 812 includes an order ID, item details, shipping address, and payment status. In instances where the request contains errors or omits information, the API gateway 804 uses the model to modify the API traffic 812 from the application to align with the model's prediction. For example, if any predicted critical information, such as the shipping/billing address or payment status, is missing or incomplete, the API gateway 804 populates the fields with the appropriate data retrieved from the e-commerce platform's database to ensure that the customer has an accurate representation of the order details for later reference. In some embodiments, the model recognizes the omission by calculating the probability of the observed API traffic 812 given the context of order confirmation details. If the absence of the shipping address deviates from expected patterns in the training data, the omission is flagged as an anomaly and filled in according to the predicted content.

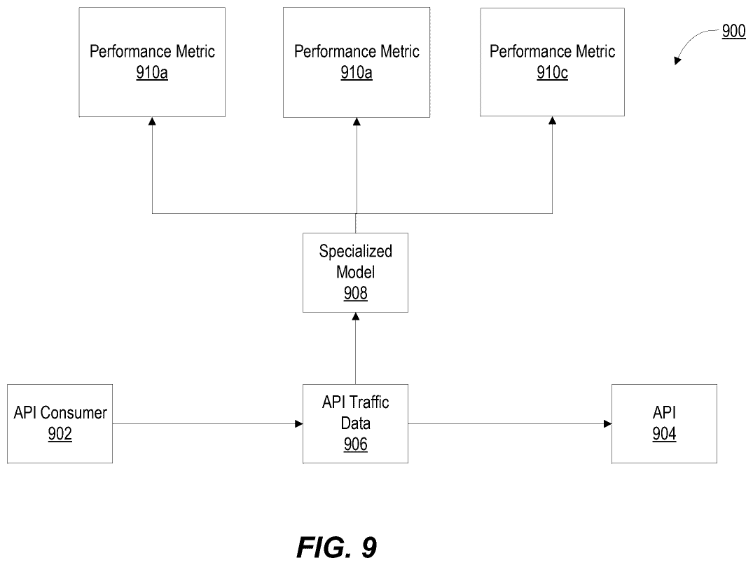

FIG. 9 is a block diagram 900 illustrating generating performance metrics for the specialized model to iteratively refine the specialized model, according to an embodiment of the disclosed technology.

The API consumer 902 interacts with the API 904 by sending requests and receiving responses, generating a stream of API traffic data 906. The API traffic data 906 includes, for example, various elements such as request headers, response headers, payload content, and other metadata associated with each API interaction.

The specialized model 908 that is generated by applying training data generated from the API traffic data 906 uses, in some embodiments, machine learning algorithms to analyze the API traffic data and make predictions and/or classifications based on the observed patterns and behaviors. In some embodiments, the algorithms include techniques such as deep learning, neural networks, or ensemble methods.

To evaluate the performance of the specialized model, performance metrics 910a-c are generated to quantify the model's performance in terms of accuracy, precision, recall, F1 score, and/or other relevant measures. Generating performance metrics involves comparing the predictions made by the model against known outcomes to assess the specialized model's 908 effectiveness.

Accuracy measures the overall correctness of the model's predictions by calculating the ratio of correctly predicted instances to the total number of instances. The metric provides an indication of the model's overall effectiveness in making correct predictions. Precision focuses on the proportion of true positive predictions out of all positive predictions made by the model. The metric quantifies the model's ability to avoid false positives, thereby ensuring that the positive predictions are indeed accurate. Recall (e.g., sensitivity, true positive rate), assesses the model's ability to capture relevant instances of a particular class. The metric calculates the ratio of true positive predictions to the total number of actual positive instances. The F1 score is a composite metric that combines precision and recall into a single value. The metric provides a balanced measure of the model's performance by considering both the precision and recall values.

In some embodiments, the process of generating performance metrics is iterative, allowing the API gateway to continuously monitor and refine the model based on the feedback provided by these metrics. The iterative refinement process involves, for example, adjusting the model's parameters, fine-tuning the model's architecture, or retraining the model with additional data to improve the model's performance over time.

For example, for each financial transaction, the specialized model makes predictions about whether the financial transaction is likely to be fraudulent based on various features and patterns (e.g., the number of declined payments in the last hour). For example, the accuracy metric measures the percentage of correctly classified transactions out of all transactions analyzed, and precision quantifies the proportion of correctly classified fraudulent transactions out of all transactions predicted as fraudulent. When the precision metric indicates that the model is falsely flagging a significant number of legitimate transactions as fraudulent (resulting in a high false positive rate), in response, the platform adjusts the model's parameters, such as fine-tuning the decision threshold or modifying the feature selection process, to improve the model's performance.

### Computing Platform

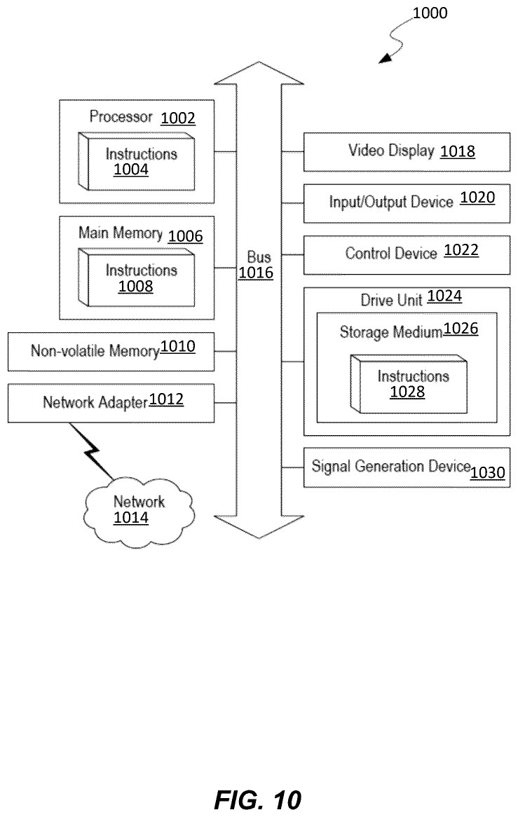

FIG. 10 is a block diagram illustrating an example computer system 1000, in accordance with one or more embodiments. In some embodiments, components of the example computer system 1000 are used to implement the software platforms described herein. At least some operations described herein can be implemented on the computer system 1000.

In some embodiments, the computer system 1000 includes one or more central processing units (“processors”) 1002, main memory 1006, non-volatile memory 1010, network adapters 1012 (e.g., network interface), video displays 1018, input/output devices 1020, control devices 1022 (e.g., keyboard and pointing devices), drive units 1024 including a storage medium 1026, and a signal generation device 1020 that are communicatively connected to a bus 1016. The bus 1016 is illustrated as an abstraction that represents one or more physical buses and/or point-to-point connections that are connected by appropriate bridges, adapters, or controllers. The bus 1016, therefore, includes a system bus, a peripheral component interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1094 bus (also referred to as “Firewire”).

In some embodiments, the computer system 1000 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 1000.

While the main memory 1006, non-volatile memory 1010, and storage medium 1026 (also called a “machine-readable medium”) are shown to be a single medium, the terms “machine-readable medium” and “storage medium” should be taken to include a single medium or multiple media (e.g., a centralized/distributed database and/or associated caches and servers) that store one or more sets of instructions 1028. The term “machine-readable medium” and “storage medium” shall also be taken to include any medium that is capable of storing, encoding, or carrying a set of instructions for execution by the computer system 1000. In some embodiments, the non-volatile memory 1010 or the storage medium 1026 is a non-transitory, computer-readable storage medium storing computer instructions, which is executable by one or more “processors” 1002 to perform functions of the embodiments disclosed herein.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 1004, 1008, 1028) set at various times in various memory and storage devices in a computer device. When read and executed by one or more processors 1002, the instruction(s) cause the computer system 1000 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually affect the distribution.

Further examples of machine-readable storage media, machine-readable media, or computer-readable media include recordable-type media such as volatile and non-volatile memory devices 1010, floppy and other removable disks, hard disk drives, optical discs (e.g., compact disc read-only memory (CD-ROMS), digital versatile discs (DVDs)), and transmission-type media such as digital and analog communication links.

The network adapter 1012 enables the computer system 1000 to mediate data in a network 1014 with an entity that is external to the computer system 1000 through any communication protocol supported by the computer system 1000 and the external entity. The network adapter 1012 includes a network adapter card, a wireless network interface card, a router, an access point, a wireless router, a switch, a multilayer switch, a protocol converter, a gateway, a bridge, a bridge router, a hub, a digital media receiver, and/or a repeater.

In some embodiments, the network adapter 1012 includes a firewall that governs and/or manages permission to access proxy data in a computer network and tracks varying levels of trust between different machines and/or applications. The firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). In some embodiments, the firewall additionally manages and/or has access to an access control list that details permissions, including the access and operation rights of an object by an individual, a machine, and/or an application, and the circumstances under which the permission rights stand.

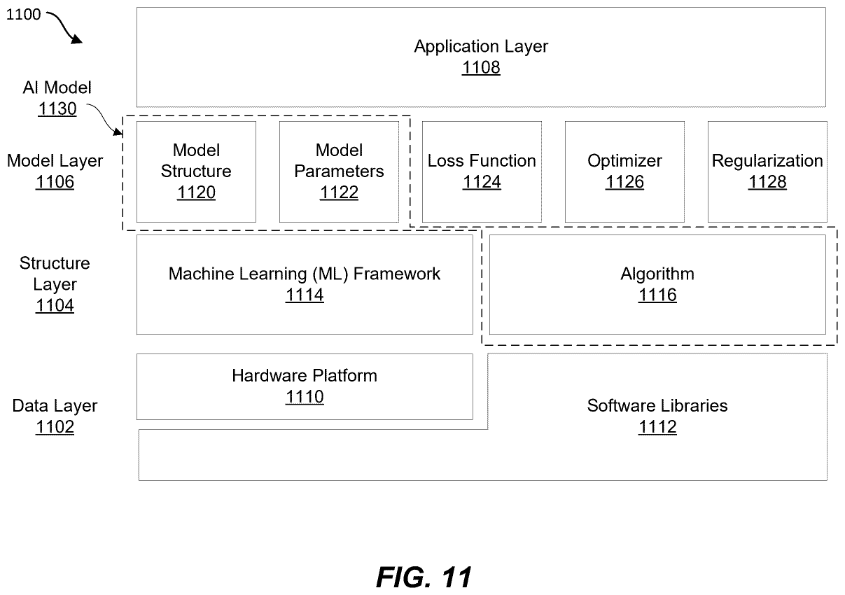

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc. A portion of the methods described herein can be performed using the example ML system 1100 illustrated and described in more detail with reference to FIG. 11.

### AI System

FIG. 11 is a high-level block diagram illustrating an example AI system, in accordance with one or more embodiments. The AI system 1100 is implemented using components of the example computer system 1100 illustrated and described in more detail with reference to FIG. 10. Likewise, embodiments of the AI system 1100 include different and/or additional components or be connected in different ways.

In some embodiments, as shown in FIG. 11, the AI system 1100 includes a set of layers, which conceptually organize elements within an example network topology for the AI system's architecture to implement a particular AI model 1130. Generally, an AI model 1130 is a computer-executable program implemented by the AI system 1100 that analyses data to make predictions. Information passes through each layer of the AI system 1100 to generate outputs for the AI model 1130. The layers include a data layer 1102, a structure layer 1104, a model layer 1106, and an application layer 1108. The algorithm 1116 of the structure layer 1104 and the model structure 1120 and model parameters 1122 of the model layer 1106 together form the example AI model 1130. The optimizer 1126, loss function engine 1124, and regularization engine 1128 work to refine and optimize the AI model 1130, and the data layer 1102 provides resources and support for the application of the AI model 1130 by the application layer 1108.

The data layer 1102 acts as the foundation of the AI system 1100 by preparing data for the AI model 1130. As shown, in some embodiments, the data layer 1102 includes two sub-layers: a hardware platform 1110 and one or more software libraries 1112. The hardware platform 1110 is designed to perform operations for the AI model 1130 and includes computing resources for storage, memory, logic, and networking, such as the resources described in relation to FIG. 1. The hardware platform 1110 processes amounts of data using one or more servers. The servers can perform backend operations such as matrix calculations, parallel calculations, machine learning (ML) training, and the like. Examples of servers used by the hardware platform 1110 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 1110 includes Infrastructure as a Service (IaaS) resources, which are computing resources, (e.g., servers, memory, etc.) offered by a cloud services provider. In some embodiments, the hardware platform 1110 includes computer memory for storing data about the AI model 1130, application of the AI model 1130, and training data for the AI model 1130. In some embodiments, the computer memory is a form of random-access memory (RAM), such as dynamic RAM, static RAM, and non-volatile RAM.

In some embodiments, the software libraries 1112 are thought of as suites of data and programming code, including executables, used to control the computing resources of the hardware platform 1110. In some embodiments, the programming code includes low-level primitives (e.g., fundamental language elements) that form the foundation of one or more low-level programming languages, such that servers of the hardware platform 1110 can use the low-level primitives to carry out specific operations. The low-level programming languages do not require much, if any, abstraction from a computing resource's instruction set architecture, allowing them to run quickly with a small memory footprint. Examples of software libraries 1112 that can be included in the AI system 1100 include Intel Math Kernel Library, Nvidia cuDNN, Eigen, and Open BLAS.

In some embodiments, the structure layer 1104 includes an ML framework 1114 and an algorithm 1116. The ML framework 1114 can be thought of as an interface, library, or tool that allows users to build and deploy the AI model 1180. In some embodiments, the ML framework 1114 includes an open-source library, an application programming interface (API), a gradient-boosting library, an ensemble method, and/or a deep learning toolkit that works with the layers of the AI system facilitate development of the AI model 1130. For example, the ML framework 1114 distributes processes for the application or training of the AI model 1130 across multiple resources in the hardware platform 1110. In some embodiments, the ML framework 1114 also includes a set of pre-built components that have the functionality to implement and train the AI model 1130 and allow users to use pre-built functions and classes to construct and train the AI model 1130. Thus, the ML framework 1114 can be used to facilitate data engineering, development, hyperparameter tuning, testing, and training for the AI model 1130. Examples of ML frameworks 1114 that can be used in the AI system 1100 include TensorFlow, PyTorch, Scikit-Learn, Keras, Caffe, LightGBM, Random Forest, and Amazon Web Services.

In some embodiments, the algorithm 1116 is an organized set of computer-executable operations used to generate output data from a set of input data and can be described using pseudocode. In some embodiments, the algorithm 1116 includes complex code that allows the computing resources to learn from new input data and create new/modified outputs based on what was learned. In some implementations, the algorithm 1116 builds the AI model 1130 through being trained while running computing resources of the hardware platform 1110. The training allows the algorithm 1116 to make predictions or decisions without being explicitly programmed to do so. Once trained, the algorithm 1116 runs at the computing resources as part of the AI model 1130 to make predictions or decisions, improve computing resource performance, or perform tasks. The algorithm 1116 is trained using supervised learning, unsupervised learning, semi-supervised learning, and/or reinforcement learning.

The application layer 1108 describes how the AI system 1100 is used to solve problems or perform tasks. In an example implementation, API gateway 106 uses the application layer 1108 to intercept communication between the API consumer 102 and API 104.

As an example, to train an AI model 1130 that is intended to model human language (also referred to as a language model), the data layer 1102 is a collection of text documents, referred to as a text corpus (or simply referred to as a corpus). The corpus represents a language domain (e.g., a single language), a subject domain (e.g., scientific papers), and/or encompasses another domain or domains, be they larger or smaller than a single language or subject domain. For example, a relatively large, multilingual, and non-subject-specific corpus is created by extracting text from online web pages and/or publicly available social media posts. In some embodiments, data layer 1102 is annotated with ground truth labels (e.g., each data entry in the training dataset is paired with a label), or unlabeled.

Training an AI model 1130 generally involves inputting into an AI model 1130 (e.g., an untrained ML model) data layer 1102 to be processed by the AI model 1130, processing the data layer 1102 using the AI model 1130, collecting the output generated by the AI model 1130 (e.g., based on the inputted training data), and comparing the output to a desired set of target values. If the data layer 1102 is labeled, the desired target values, in some embodiments, are, e.g., the ground truth labels of the data layer 1102. If the data layer 1102 is unlabeled, the desired target value is, in some embodiments, a reconstructed (or otherwise processed) version of the corresponding AI model 1130 input (e.g., in the case of an autoencoder), or is a measure of some target observable effect on the environment (e.g., in the case of a reinforcement learning agent). The parameters of the AI model 1130 are updated based on a difference between the generated output value and the desired target value. For example, if the value outputted by the AI model 1130 is excessively high, the parameters are adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the AI model 1130 typically is to minimize a loss function or maximize a reward function.

In some embodiments, the data layer 1102 is a subset of a larger data set. For example, a data set is split into three mutually exclusive subsets: a training set, a validation (or cross-validation) set, and a testing set. The three subsets of data, in some embodiments, are used sequentially during AI model 1130 training. For example, the training set is first used to train one or more ML models, each AI model 1130, e.g., having a particular architecture, having a particular training procedure, being describable by a set of model hyperparameters, and/or otherwise being varied from the other of the one or more ML models. The validation (or cross-validation) set, in some embodiments, is then used as input data into the trained ML models to, e.g., measure the performance of the trained ML models and/or compare performance between them. In some embodiments, where hyperparameters are used, a new set of hyperparameters is determined based on the measured performance of one or more of the trained ML models, and the first step of training (i.e., with the training set) begins again on a different ML model described by the new set of determined hyperparameters. These steps are repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) begins in some embodiments. The output generated from the testing set, in some embodiments, is compared with the corresponding desired target values to give a final assessment of the trained ML model's accuracy. Other segmentations of the larger data set and/or schemes for using the segments for training one or more ML models are possible.

Backpropagation is an algorithm for training an AI model 1130. Backpropagation is used to adjust (also referred to as update) the value of the parameters in the AI model 1130, with the goal of optimizing the objective function. For example, a defined loss function is calculated by forward propagation of an input to obtain an output of the AI model 1130 and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. In some embodiments, other techniques for learning the parameters of the AI model 1130 are used. The process of updating (or learning) the parameters over many iterations is referred to as training. In some embodiments, training is carried out iteratively until a convergence condition is met (e.g., a predefined maximum number of iterations has been performed, or the value outputted by the AI model 1130 is sufficiently converged with the desired target value), after which the AI model 1130 is considered to be sufficiently trained. The values of the learned parameters are then fixed and the AI model 1130 is then deployed to generate output in real-world applications (also referred to as “inference”).

In some examples, a trained ML model is fine-tuned, meaning that the values of the learned parameters are adjusted slightly in order for the ML model to better model a specific task. Fine-tuning of an AI model 1130 typically involves further training the ML model on a number of data samples (which may be smaller in number/cardinality than those used to train the model initially) that closely target the specific task. For example, an AI model 1130 for generating natural language that has been trained generically on publicly available text corpora is, e.g., fine-tuned by further training using specific training samples. In some embodiments, the specific training samples are used to generate language in a certain style or a certain format. For example, the AI model 1130 is trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

In some embodiments, the language model uses a neural network (typically a DNN) to perform NLP tasks. A language model is trained to model how words relate to each other in a textual sequence, based on probabilities. In some embodiments, the language model contains hundreds of thousands of learned parameters, or in the case of a large language model (LLM) contains millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

Although a general transformer architecture for a language model and the model's theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that is considered to be an encoder-only language model. A decoder-only language model accepts embeddings as input and uses auto-regression to generate an output text sequence. Transformer-XL and GPT-type models are language models that are considered to be decoder-only language models.

Because GPT-type language models tend to have a large number of parameters, these language models are considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that GPT-3 can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model is hosted by a computer system that includes a plurality of cooperating (e.g., cooperating via a network) computer systems that are in, for example, a distributed arrangement. Notably, a remote language model employs a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real-time or near real-time) can require the use of a plurality of processors/cooperating computing devices as discussed above.

In some embodiments, inputs to an LLM are referred to as a prompt (e.g., command set or instruction set), which is a natural language input that includes instructions to the LLM to generate a desired output. In some embodiments, a computer system generates a prompt that is provided as input to the LLM via the LLM's API. As described above, the prompt is processed or pre-processed into a token sequence prior to being provided as input to the LLM via the LLM's API. A prompt includes one or more examples of the desired output, which provides the LLM with additional information to enable the LLM to generate output according to the desired output. Additionally or alternatively, the examples included in a prompt provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples is referred to as a zero-shot prompt.

In some embodiments, the llama2 is used as a large language model, which is a large language model based on an encoder-decoder architecture, and can simultaneously perform text generation and text understanding. The llama2 selects or trains proper pre-training corpus, pre-training targets and pre-training parameters according to different tasks and fields, and adjusts a large language model on the basis so as to improve the performance of the large language model under a specific scene.

In some embodiments, the Falcon40B is used as a large language model, which is a causal decoder-only model. During training, the model predicts the subsequent tokens with a causal language modeling task. The model applies rotational positional embeddings in the model's transformer model and encodes the absolution positional information of the tokens into a rotation matrix.

In some embodiments, the Claude is used as a large language model, which is an autoregressive model trained on a large text corpus unsupervised.

Consequently, alternative language and synonyms can be used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this invention and that various modifications can be implemented by those skilled in the art.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described but can be practiced with modification and alteration within the spirit and scope of the appended claims. Accordingly, the specification and drawings are to be regarded in an illustrative sense rather than a restrictive sense.

I/we claim:

1. A method for training a model for a microservice application based on Application Programming Interface (API) traffic, comprising:
establishing a microservice architecture application including a plurality of services,
wherein each of the plurality of services is configured to perform a piecemeal function of an overall application function,
wherein one or more services within the plurality of services are associated with API traffic of the one or more services to an API gateway, and
wherein the API gateway is configured to observe and copy the API traffic of the one or more services;
receiving, via the API gateway, a set of communications from the API traffic received from or sent to the one or more services of the microservice architecture application;
generating, via the API gateway, a copy of the set of communications,
wherein the API gateway is configured to train an artificial intelligence (AI) model to generate a specialized model using at least a portion of the set of communications as training data,
wherein the AI model captures patterns or behaviors associated with the one or more services;
in response to generating the copy of the set of communications, parsing through each communication within the copy via the API gateway to determine the training data; and
applying the training data to the AI model to generate a specialized model, wherein the specialized model captures the patterns or the behaviors associated with the one or more services using the training data.

2. The method of claim 1,
wherein the copy of the set of communications is categorized based on variables indicative of a particular attribute across the copy of the set of communications,
wherein the training data of a request within the copy of the set of communications includes a corresponding title of the particular attribute, and
wherein the training data of a response within the copy of the set of communications includes an answer to the title of the particular attribute for the corresponding request.

3. The method of claim 2, further comprising:
initiating implementation of the specialized model on the API traffic received from or sent to the one or more services of the microservice architecture application; and
determining a variable using semantic analysis based on a particular response of the API traffic for a corresponding request of the API traffic, wherein the semantic analysis infers the corresponding title for the variable based on the answer to the corresponding title of the variable.

4. The method of claim 1, wherein the API gateway is configured to observe and copy the API traffic of the one or more services using one or more of: a session layer (5), a presentation layer (L6), or an application layer (L7) of an Open Systems Interconnection (OSI) model.

5. The method of claim 1, wherein the specialized model is stored in a cloud environment hosted by a cloud provider with scalable resources or a self-hosted environment hosted by a local server.

6. The method of claim 1, further comprising:
receiving, via the API gateway, a new set of communications;
initiating implementation of the specialized model on the new set of communications to identify any anomalies in the new set of communications, wherein the anomalies relate to satisfaction according to said initiating implementation of the specialized model; and
in response to identifying the anomalies, modifying the new set of communications to correct the anomaly.

7. The method of claim 6, wherein said modifying the new set of communications includes discarding a subset of the new set of communications.

8. A method for training a model for a microservice application based on Application Programming Interface (API) traffic, comprising:
establishing a microservice architecture application including a plurality of services,
wherein each of the plurality of services is configured to perform a piecemeal function of an overall application function,
wherein one or more services within the plurality of services are associated with API traffic of the one or more services to an API gateway, and
wherein the API gateway is configured to observe the API traffic of the one or more services;
intercepting, via the API gateway, a set of communications from the API traffic received from or sent to the one or more services,
wherein the one or more services are configured to consume an API within the microservice architecture application,
wherein the API gateway is configured to train an artificial intelligence (AI) model to generate a specialized model using at least a portion of the set of communications as training data, and
wherein the AI model captures patterns or behaviors associated with the one or more services;
parsing through each communication within the set of communications via the API gateway to determine the training data; and
applying the training data to the AI model to generate a specialized model, wherein the specialized model captures the patterns or the behaviors associated with the one or more services using the training data.

9. The method of claim 8, wherein the API gateway is a first gateway, wherein the API traffic is a first API traffic, further comprising:
providing a second gateway associated with a second API traffic of the one or more services to the second gateway, wherein the second gateway is configured to observe the second API traffic of the one or more services;
intercepting the second API traffic, via the second gateway, received from or sent to the one or more services of the microservice architecture application;
parsing through, via the second gateway, a new set of communications within the intercepted second API traffic to determine new training data; and
directing, via the second gateway, said generating the specialized model based on the new training data.

10. The method of claim 8,
receiving feedback on the specialized model related to performance metrics of the specialized model when implemented on the API traffic, and
dynamically adjusting parameters of the specialized model based on the received feedback.

11. The method of claim 8, wherein the specialized model is a specialized model, further comprising:
obtaining a foundation model including base parameters associated with the set of communications associated with the API traffic; and
directing said training of the specialized model by updating the base parameters of the foundation model based on the training data.

12. The method of claim 8, wherein the training data includes one or more of:
frequency or speed at which the set of communications are received from or sent to the one or more services.

13. The method of claim 8, further comprising:
monitoring performance metrics of the specialized model when implemented on the API traffic; and
iteratively refining the specialized model based on the monitored performance metrics of the specialized model.

14. The method of claim 8,
wherein the training data is a subset of the intercepted API traffic,
wherein the training data is identified by filtering the intercepted API traffic based on predefined parameters.

15. A system for training a model for a microservice application based on Application Programming Interface (API) traffic, comprising:
a microservice architecture application including a plurality of services,
wherein each of the plurality of services are configured to perform a piecemeal function of an overall application function, and
wherein one or more services within the plurality of services are configured to consume an API within the microservice architecture application;
an API gateway associated with one or more services of the plurality of services,
wherein the one or more services are associated with API traffic of the one or more services to an API gateway,
wherein the API gateway is configured to observe and intercept a set of communications from the API traffic received from or sent to the one or more services, and
wherein the API gateway is configured to receive a specialized model;
a data module configured to, in response to intercepting a set of communications, parse through each communication within the set of communications via the API gateway to determine the training data; and
a training module configured to, in response to receiving training data, apply the training data to an artificial intelligence (AI) model to generate a specialized model,
wherein the specialized model captures patterns or behaviors associated with the one or more services using the training data.

16. The system of claim 15, wherein a duration of said training the AI model is adjustable by users of the API gateway, wherein said training the AI model terminates upon reaching the duration.

17. The system of claim 15, further comprising a traffic selection module configured to provide options for users of the API gateway to specify filtering criteria for extracting the training data, wherein the filtering criteria filters the intercepted API traffic.

18. The system of claim 15, further comprising an update module configured to:
intercept new API traffic;
extract new training data for the AI model based on the new API traffic;
training the AI model by applying the new training data to the training module; and
dynamically adjust parameters of the AI model based on said training on the new API traffic.

19. The system of claim 15, wherein the intercepted API traffic includes one or more of: request headers, response headers, payload content, connection information, security information, operational data, or performance metrics.

20. The system of claim 15, wherein the AI model is a specialized model, further comprising:
receiving a foundation model including base parameters associated with the set of communications associated with the API traffic; and
directing said training of the specialized model by updating the base parameters of the foundation model to the training data.
